(19) United States
(12) Patent Application Publication
(10) Pub. No.: US 2010/0171773 A1
(43) Pub. Date: Jul. 8, 2010

(54) CIRCUIT ARRANGEMENT AND ACTUATION METHOD FOR SEMI-CONDUCTOR LIGHT SOURCES

(75) Inventors: Ralf Hying, Muenchen (DE); Peter Niedermeier, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/663,012

(22) PCT Filed: Jun. 13, 2007
(86) PCT No.: PCT/EP07/55792

§ 371 Date: Dec. 4, 2009

(51) Int. Cl. G09G 5/10

(52) U.S. Cl. 345/690

(57) ABSTRACT

A circuit arrangement for driving semiconductor light sources is provided. The circuit arrangement may include video electronics, which are configured to generate a timing signal and an image value table; a driver circuit, which comprises a digital and an analogue part, and a semiconductor light source module, which can contain one or a plurality of semiconductor light sources; and a switch being arranged between the driver circuit and the semiconductor light source module, which switch is driven by the driver circuit and can switch the desired value for the power supply for the semiconductor light source module away from an analogue/digital converter to logic 0.

### TECHNICAL FIELD

The invention relates to projection devices equipped with semiconductor light sources. Microdisplay applications for front and rear projection can primarily be mentioned here.

### PRIOR ART

Recently, powerful semiconductor light sources such as high-power light emitting diodes have increasingly been used in applications which had previously been reserved for high-pressure discharge lamps. Precisely in the field of projection, the semiconductor light sources are not driven continuously, but rather operated in pulsed fashion in order to meet the requirements there. In that case, very short pulses are employed, which in return have a very high power density.

A plurality of colors, usually at least 3 colors, are used in display applications. The drive circuit is divided into video electronics, which condition the input signal, and driver electronics, which are often split into a digital and an analogue part connected via a digital/analogue converter. In accordance with the input signal, the video electronics pass instructions to the driver electronics to switch on a specific color. In the digital part of the driver electronics, a process is thereupon initiated which, after a specific time, results in the outputting of a brightness value for the desired color. Said brightness value and the timing are held in a table generated by the video electronics. In response to the request of the video electronics, the so-called strobe, the digital driver electronics read out said table and generate a desired value signal on the basis of the values read out. The analogue driver part thereupon switches on the corresponding colored semiconductor light source with the desired brightness. Since the colors are projected successively in display applications, the semiconductor light sources have to be switched off again after the pulse that has been output in order that the next color can be projected. This requires a further cycle in the digital driver electronics. A zero value has to be input into the buffer memory of the analogue/digital converter and said value then has to be output as analogue value, whereupon the analogue part switches off the semiconductor light source again.

Therefore, a certain time elapses between the strobe signal and the actual switching on or off of the semiconductor light source. In the case of switching on the semiconductor light sources this does not pose a problem since this delay time is known to the video electronics and concommitently taken into account in the timing. In the case of switch-off, however, this can pose a problem since the minimum switched-on duration is dependent on the processing speed for the driver electronics. For this reason, the driver electronics must have a fast logic and fast analogue/digital converter since otherwise they cannot achieve the required processing speed. However, fast analogue/digital converters and a fast logic (e.g. a highly clocked microcontroller) are very cost-intensive, which has a disadvantageous effect on the pricing of the end product.

### Object

Therefore, it is an object of the invention to propose a drive method and a circuit arrangement which no longer have the disadvantages mentioned above and manage with a slower and therefore more cost-effective logic.

### SUMMARY OF THE INVENTION

This object is achieved by means of the features of patent claim 1 and of method claim 7. Particularly advantageous embodiments of the invention are described in the dependent claims.

The invention is based on the fact that the semiconductor light sources is always switched off after the pulsed light emission. This makes it possible to input a new value into the analogue/digital converter only once and to switch the semiconductor light source on and off by means of a switch. This has the advantage that slow components can be used without restricting the performance of the overall arrangement.

### BRIEF DESCRIPTION OF THE DRAWING(S)

FIG. 1 Block diagram of a circuit arrangement according to the prior art.

FIG. 2 Block diagram of a circuit arrangement according to the invention.

FIG. 3 Comparison of some relevant signal profiles according to the prior art and the present invention.

### PREFERRED EMBODIMENT OF THE INVENTION

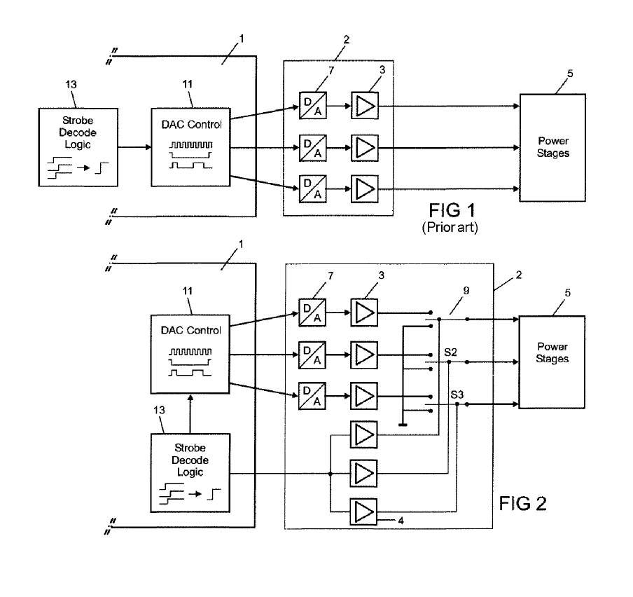

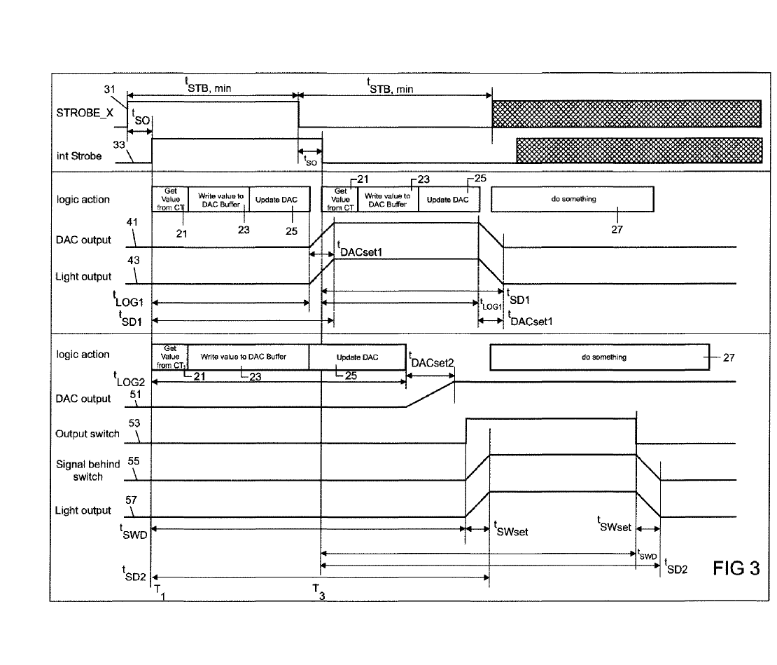

The block diagram of a circuit arrangement according to the prior art is shown in FIG. 1. The digital part of driver electronics 1 contains a timing signal decoding logic 13, and a control logic 11 for the digital/analogue converter 7. The analogue part comprises a digital/analogue converter 7, a control logic 3 and the light emitting diode modules 5. The light emitting diode modules 5 include the power drivers for the LEDs and the LEDs themselves. The analogue brightness signal is input into the power drivers, which signal then switches on the LEDs to the desired brightness level or, in the case of an analogue signal corresponding to logic zero, switches them off. The timing signal decoding logic receives the timing signal (strobe) from the video electronics (not shown). The timing signal is processed, and the timing signal decoding logic outputs a start signal to the control logic 11 at the correct point in time. Said logic reads out a table which is generated by the video electronics and in which timing and brightness values for the various phases of an image are stored. The sequence which then follows can thus be seen from FIG. 3. The upper third depicts the timing signals generated by the video electronics, and the middle third depicts the actions and signals of a circuit arrangement according to the prior art.

The block 21 represents the read-out of the table. This begins at the instant T₁, as soon as the timing signal is logic 1. As soon the values from the table have been determined, they are written to the buffer memory of the digital/analogue converter (block 23). In block 25, as soon as the buffer memory has been completely updated, the digital/analogue converter is put into action, with the result that an analogue signal corresponding to the digital value is present at the analogue output. The driver circuit requires the time t_{LOG1} for all this. As soon as the analogue signal is output, the analogue part of the driver circuit switches on the LED modules 5. This process requires the time t_{DACset1}.

At the instant T₃, the timing signal becomes logic zero again. At this instant, the entire procedure is run through a further time in order to set the analogue value to zero again and thus to switch off the LED module. The time between the instants T₁ and T₂ is equal to the timing signal duration t_{STB}. The processing time t_{LOG1} is crucially responsible for the minimum pulse duration of the entire arrangement, because if the duration of the processing time t_{LOG1} comes close to the minimum timing signal duration t_{STB.min}, the timing can no longer be complied with. The minimum pulse length and thus the minimum timing signal duration t_{STB.min} are therefore directly dependent on the processing speed of the driver circuit.

This is the starting point for the invention. According to the invention, the analogue/digital converter is used only for setting the brightness, with the result that, for each color, said converter now only has to run through the conversion procedure once instead of twice. A switch is arranged between the analogue output downstream of the control logic 3 and the LED module, which switch either switches the analogue value of the analogue/digital converter through the LED module or switches the analogue input of the LED module to ground, which corresponds to a logic zero. The signals and actions of a drive method according to the present invention are shown in the lower third of FIG. 3. As can be seen from the length of the logic blocks 21-25, the processing time is significantly longer, that is to say that the processing speed is lower. This results from the use of more cost-effective components that operate more slowly.

The signal 51 describes the output of the digital/analogue converter. The latter is switched over as soon as the digital processing is concluded. This takes the time t_{LOG2}, which is longer than the time t_{LOG1}. As soon as the analogue/digital converter has reliably switched over, the switch S_{X} of the corresponding color is switched on (signal 53). The power driver thus receives the analogue signal 51 from the digital/analogue converter and switches on the LEDs (signals 55, 57).

After the time t_{STB}, that is to say the pulse duration, the switch is switched to ground again, whereupon the LEDs are switched off. In this case, the analogue/digital converter remains at its original value, that is to say that the analogue/digital converter signal is not brought to zero. For the next cycle, the analogue/digital converter is merely set to the new brightness.

By virtue of the fact that the analogue/digital converter only operates for setting the brightness, the processing time is significantly less critical. The analogue/digital converter, after all only operates before the pulse, that is to say that the delay time of the converter is unimportant for the minimum pulse length. The invention, on the contrary, has the major advantage of being able to realize very short minimum pulse lengths, since practically no processing has to take place during the pulse, rather the majority of the processing can take place during the pulse intermissions. Since the longer processing time before the pulse can easily be compensated for by the video electronics, the drive method according to the invention has no disadvantages whatsoever even in the case of components operating more slowly.

The time available to the driver electronics to accomplish other things as can be seen from block 27, is likewise lengthened by comparison with the prior art. A further advantage is that this time can occur during the pulse and during the pulse intermissions.

1. A circuit arrangement for driving semiconductor light sources, comprising:
video electronics, which are configured to generate a timing signal and an image value table;
a driver circuit, which comprises a digital and an analogue part, and a semiconductor light source module, which can contain one or a plurality of semiconductor light sources; and
a switch being arranged between the driver circuit and the semiconductor light source module, which switch is driven by the driver circuit and can switch the desired value for the power supply for the semiconductor light source module away from an analogue/digital converter to logic 0.

2. The circuit arrangement as claimed in claim 1, wherein the digital part of the driver circuit comprises a microcontroller.

3. The circuit arrangement as claimed in claim 2, wherein the switch is driven by a timing signal decoding logic.

4. The circuit arrangement as claimed in claim 2, wherein all the switches are controlled jointly by an output.

5. The circuit arrangement as claimed in claim 2, wherein each switch is controlled individually by an output.

6. The circuit arrangement as claimed in claim 2, wherein the switches are controlled individually by an output, wherein the output is configured to output a coded signal, and the switch drive circuit has a decoding logic that is configured to switch the respective switch on and off on the basis of the coded signal.

7. A drive method for driving semiconductor light sources, the method comprising:
video electronics generating a timing signal;
a driver circuit, which comprises a digital and an analogue part, outputting an analogue brightness signal that is input into a power driver;
wherein the input of the power driver can be switched from an analogue/digital converter to ground.

8. The drive method as claimed in claim 7, wherein the switch-over is realized by a timing signal decoding unit.
